(19) United States
(12) Patent Application Publication
(10) Pub. No.: US 2026/0211233 A1
(43) Pub. Date: Jul. 23, 2026

(54) IMAGE-GENERATING DEVICE AND HEAD-UP DISPLAY COMPRISING SUCH A DEVICE

(71) Applicant: Valeo Comfort and Driving Assistance, Créteil (FR)

(72) Inventors: Pierre Mermillod, Créteil (FR); Ayoub Ben-Nachouane, Créteil (FR)

(73) Assignee: Valeo Comfort and Driving Assistance, Créteil (FR)

(21) Appl. No.: 19/142,482

(22) PCT Filed: Dec. 12, 2023
(86) PCT No.: PCT/EP2023/085321

§ 371 Date: Jun. 23, 2025

(30) Foreign Application Priority Data
Dec. 23, 2022 (FR) FR2214415

(51) Int. Cl. G02B 27/01

(52) U.S. Cl. CPC G02B 27/0101; G02B 27/0149

(57) ABSTRACT

Described is an image-generating device that includes a light source configured to produce a light beam and an array of variable transmittance elements. The array of variable transmittance elements includes an optically useful zone configured to selectively transmit the light beam. The image-generating device includes a thermally conductive opaque mask located at a distance from the array of variable transmittance elements. The opaque mask is configured to block some light rays in a direction of the optical path that passes through a non-optically useful zone and to allow the passage of light rays in a direction of the optical path that passes through the optically useful zone, where the opaque mask is thermally coupled to a heat sink.

### Technical field

The present invention relates to the technical field of display, for example the display of information for the purpose of assisting the driving of motor vehicles. The invention relates more particularly to an image-generating device and a head-up display comprising such a device.

### TECHNOLOGICAL BACKGROUND

The principle of automotive head-up displays is to project images, comprising for example information that is useful for driving, directly into the field of view of a driver, in particular on the vehicle windshield.

To this end, head-up displays comprise an image-generating device, for example a light source coupled to an array of variable transmittance elements, for example a liquid-crystal display (LCD), and an optical system for transmitting this image to a partially transparent strip, for example in order for the driver to be able to see the images without looking away from the road.

The light power required to display an image in the field of view of the driver requires the use of a light source of very high intensity, of the order of one million candelas. However, arrays of variable transmittance elements typically have a high absorption rate, of the order of 90% for the elements (or pixels) thereof which are on, and of the order of 99% for the elements thereof which are off. The absorption of light rays by the array therefore leads to a risk of overheating and damage to the array.

Furthermore, the location of the displays under the windshield of the motor vehicle makes them likely to receive a solar flux, circulating in the display following the reverse path of the light rays coming from the light source, and converging, after passing through the optical system, at a point on the screen. The focusing of the solar rays, in addition to the rise in temperature generated by the light source itself, is liable to damage the array of variable transmittance elements.

### SUMMARY OF THE INVENTION

The present invention proposes a means of limiting the degree to which the array of variable transmittance elements heats up.

According to one aspect of the invention, there is provided an image-generating device comprising a light source configured to produce a light beam and an array of variable transmittance elements comprising at least one optically useful zone configured to selectively transmit the light beam, the device comprising a thermally conductive opaque mask located at a distance from the array of variable transmittance elements, the opaque mask being configured to block light rays the direction of the optical path of which passes through a non-optically useful zone and to allow the passage of rays of the light beam the direction of the optical path of which passes through an optically useful zone, the opaque mask being thermally coupled to a heat sink.

By virtue of the opaque mask, the heat generated by the rays of the light beam the direction of the optical path of which passes through a non-optically useful zone (i.e. rays not useful for the formation of an image) and generated by solar rays can be transferred to the heat sink and dissipated. This limits the increase in temperature of the array of variable transmittance elements. The risk of damage due to overheating of the device is therefore reduced. Additionally, the mask allows for improved contrast of the image produced. To be specific, the elements (or pixels) of the array of variable transmittance elements which are off do not always block the light completely effectively, whereas the opaque mask allows the rays to be completely blocked.

According to one embodiment, the contours of the opaque mask are obtained from the contours of the optically useful zone by a homothety with a ratio greater than one.

According to one embodiment, the opaque mask is configured to block all light rays the direction of the optical path of which passes through the non-optically useful zone.

According to one embodiment, the opaque mask is placed upstream of the array of variable transmittance elements, relative to the direction of propagation of the light rays. Placing the mask upstream of the array makes it possible to limit the degree to which the array of variable transmittance elements is heated up by the rays coming from the light source.

According to one embodiment, the upstream face of the opaque mask is covered with a reflective coating.

According to one embodiment, an at least partially transparent and thermally conductive plate is in contact with a face of the array of variable transmittance elements, the opaque mask being in contact with the at least partially transparent plate.

According to one embodiment, an optical diffuser is placed between the light source and the array of variable transmittance elements, the opaque mask being in contact with a face of the optical diffuser.

According to one embodiment, a first opaque mask is placed upstream of the array of variable transmittance elements and a second opaque mask is placed downstream of the array of variable transmittance elements, relative to the direction of propagation of the light rays.

According to one embodiment, the heat sink is placed on the periphery of the opaque mask.

According to another aspect, there is provided a head-up display comprising an image-generating device according to the invention and a control unit configured to control the array of variable transmittance elements such that the elements located outside the optically useful zone permanently have a transmittance of less than 1%.

Of course, the various features, variants and embodiments of the invention may be associated with one another in various combinations provided that they are not mutually exclusive or incompatible.

### BRIEF DESCRIPTION OF THE FIGURES

In addition, various other features of the invention will become apparent from the accompanying description that is provided with reference to the drawings, which illustrate non-limiting embodiments of the invention, and in which:

FIG. 1 illustrates an embodiment of a head-up display according to the invention,

FIG. 2 shows a particular configuration of an image-generating device according to the invention,

FIG. 3 shows a particular embodiment of an image-generating device according to the configuration of FIG. 2,

FIG. 4 shows another particular configuration of the image-generating device according to the invention,

FIG. 5 shows another particular configuration of the image-generating device according to the invention,

FIG. 6 shows another particular configuration of the image-generating device according to the invention,

FIG. 7 shows another particular configuration of the image-generating device according to the invention,

FIG. 8 shows another particular configuration of the image-generating device according to the invention,

FIG. 9 shows another particular configuration of the image-generating device according to the invention.

Note that, in these figures, structural and/or functional elements common to the various variants may have the same reference signs.

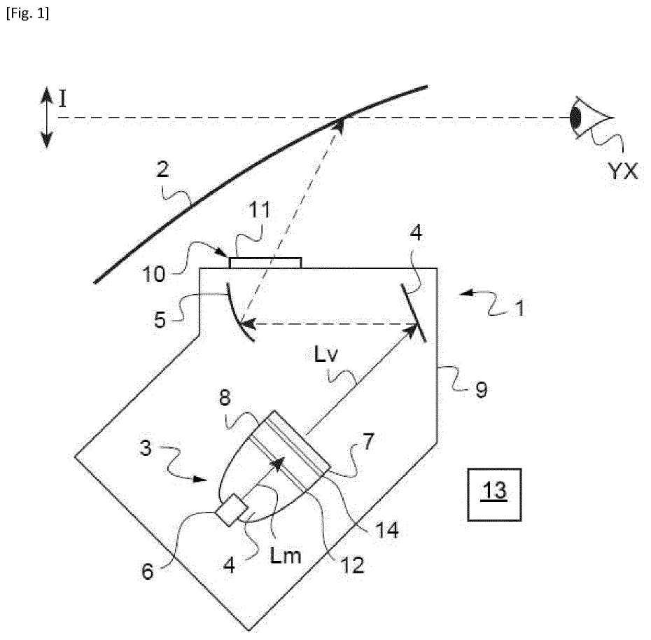

FIG. 1 schematically shows the main elements of a head-up display 1 intended, for example, to be fitted in a vehicle, for example a motor vehicle.

Such a display 1 is suitable for creating a virtual image I in the field of view of a driver of the vehicle, such that the driver can see this virtual image I and any information that it contains without having to change the direction in which they are looking.

To this end, the display 1 comprises a partially transparent strip 2 placed in the field of view of the driver, an image-generating device 3 suitable for generating a downstream light beam Lv and an optical transmission device 4, 5 suitable for reflecting, in the direction of said partially transparent strip 2, the light beam generated by the image-generating device 3.

The partially transparent strip 2 is in this case the windshield of the vehicle. In other words, it is the windshield of the vehicle that acts as a partially transparent strip for the head-up display 1.

According to a variant, the partially transparent strip could be a combiner, i.e. a partially transparent strip separate from the windshield and intended for the head-up display 1. Such a combiner would be placed between the windshield of the vehicle and the eyes YX of the driver, on the route of the downstream light beam Lv.

The optical transmission device also comprises in this case two folding mirrors 4, 5 arranged in such a way as to reflect the downstream light beam Lv generated by the image-generating device 3 in the direction of the partially transparent strip 2. The folding mirrors advantageously allow the image-generating device 3 to be placed in a configuration in which it does not face the partially transparent strip 2 and therefore to be placed in any suitable location, typically under the dashboard of the vehicle.

In this case, a first folding mirror 4 is a flat mirror and a second folding mirror 5 is a mirror having a shape optimized for producing a virtual image with a shape adapted to the shape of the partially transparent strip 2, in this case a curved shape, in such a way as to display the image I without distortion.

According to other embodiments, the optical transmission device 4, 5 may comprise a different number of mirrors and/or mirrors having different shapes, as well as other optical elements such as a lens.

The image-generating device 3 comprises a light source 6, in this case a backlight module, configured to produce an upstream light beam Lm, an array 7 of variable transmittance elements, in this case an LCD screen, configured to be illuminated by the upstream light beam Lm, and a reflector 8 interposed between the light source 6 and the array 7. A diffuser 12 is in this case placed between the light source 6 and the array of variable transmittance elements, on the optical path of the upstream light beam Lm.

The array 7 is configured to selectively transmit the upstream light beam Lm in such a way as to form the downstream light beam Lv representing an image to be projected in the field of view of the driver by means of the optical transmission device 4, 5 and the partially transparent strip 2.

The head-up display device 1 also comprises a (generally opaque) housing 9 that contains the image-generating device 2 and the optical transmission system 4, 5, notably in order to protect these elements against any external attacks (dust, liquids, etc.).

The housing 9 comprises an opening 10, through which the downstream light beam Lv passes, in this case after being reflected on the second folding mirror 5.

The opening 10 in the housing 9 is closed by a window 11 (sometimes called a “cover window”) formed, for example, from a sheet of plastic such as polycarbonate, with a thickness ranging between 0.25 mm and 0.75 mm.

The head-up display 1 further comprises a control unit 13 configured to control the image-generating device 3, in particular the light source 6 and the array of variable transmittance elements 7, in particular as a function of control signals entered by the user or coming from various sensors of the head-up display 1, as will be explained below.

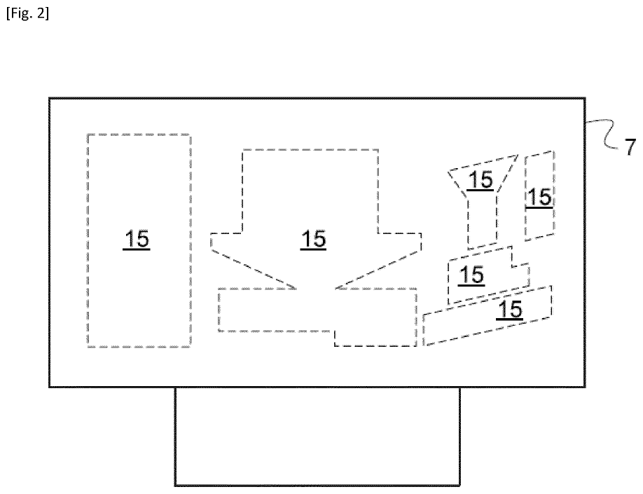

FIG. 2 is a more detailed view of the array 7 of variable transmittance elements, for example its upstream face in this case. The array 7 comprises at least one optically useful zone 15, and in particular in this case, seven optically useful zones 15. Outside the optically useful zones 15, the array of variable transmittance elements 7 is said to be non-optically useful.

For example, an optically useful zone is considered here to be a zone intended for the display of information, for example text or images. The elements, or pixels, in this zone are therefore controlled in such a way as to be optically on at least some of the time. A non-optically useful zone means a zone that is not intended for the display of information. The elements, or pixels, in a non-optically useful zone are permanently in the off state. The definition of the optically useful and non-optically useful zones is controlled by the control unit 13. Conventionally, the control unit 13 is programmed before the device 3 is sold such that the optically useful and non-optically useful zones cannot be changed. To be specific, the system designers define various zones for displaying the information provided to the driver, without overlapping in order to cover all possible situations encountered, and therefore there are in general, outside of these display zones, zones which are not used at any time. Note that an optically useful zone in which the pixels all temporarily go into the off state remains an optically useful zone. In other words, by design, the control unit 13 is configured or programmed to command each pixel of the optically useful zones into the on or off state, depending on the information to be displayed, and to command each pixel of the non-optically useful zones into the off state (permanently).

The image-generating device 3 may experience an increase in its temperature owing to the rise in the ambient temperature of the vehicle, the heat generated by the light source 6, and the solar rays which penetrate into the housing 9 via the window 11 along the reverse route of the downstream light beam Lv. In particular, the elements (or pixels) of the array which have a low transmittance, for example the non-optically useful pixels which are permanently in the off state, are more likely to experience a significant rise in temperature.

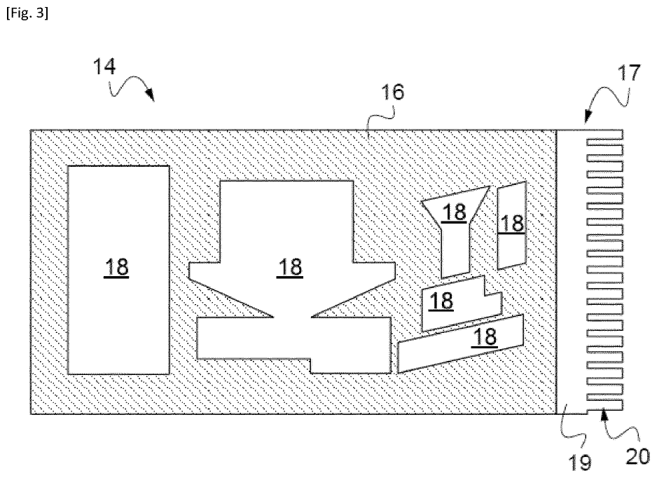

According to an advantageous feature of the invention, the image-generating device 3 comprises a heat dissipation system 14 located opposite and at a distance from the array of variable transmittance elements 7. Such a system is shown in FIG. 3.

As can be seen in FIG. 3, the heat dissipation system 14 comprises an opaque mask 16 and a heat sink 17 thermally coupled to the mask 16, for example in contact with the mask 16, and in this case located on the periphery of the mask 16. The mask 16 is in this case a rectangular flat mask, with dimensions substantially equal to those of the array of variable transmittance elements 7, comprising a plurality of openings 18, in this case a number of openings 18 equal to the number of optically useful zones 15. More specifically in this case, the positions of the openings 18 are chosen such that each opening 18 is opposite an optically useful zone 15, in other words such that a light ray coming from the light source 6, the direction of the optical path of which passes through an optically useful zone, can pass through an opening 18 and is not blocked by the mask 16.

Preferably in this case, the contour of each opening 18 is obtained from the contour of the optically useful zone 15 opposite which it is located, by virtue of a homothety with a ratio greater than 1. Preferably, the homothety ratio is close to 1 (for example 1.1 or 1.2), so as to make the mask more selective. The light rays the direction of propagation of which passes through the edges of the useful zone 15 will therefore pass close to the edges of the opening 18. Thus, a minority of rays have a direction of propagation which passes both outside an optically useful zone and through an opening 18.

The heat sink 17 is in this case a passive heat sink that relies on convection. In this case, it comprises a base 19 in contact with the mask, and a plurality of fins 20 the function of which is to increase the surface area of the heat sink 17 for contact with the air, and therefore to improve heat dissipation. The fins 20 are in this case parallel to one another and substantially parallel to the surface of the mask 16. They therefore extend from the base 19 in the direction away from the mask.

The mask 16 and the heat sink 17 are in this case made of thermally conductive materials, in other words materials having a thermal conductivity equal to or greater than 60 W·m⁻¹·k⁻¹. The heat sink 17 has a thermal conductivity at least equal to that of the mask 16. For example, in this case, the mask 16 and the heat sink 17 are made of the same material, in this case aluminum, which has a thermal conductivity of 226 W·m⁻¹·k⁻¹.

The heat dissipation system 14 may be placed in the image-generating device in different configurations.

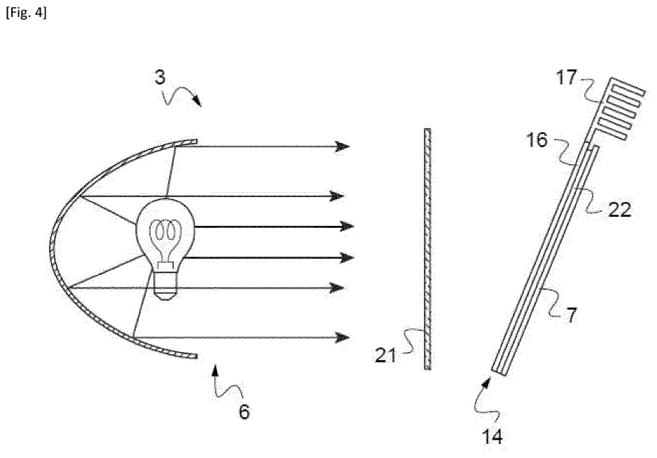

FIG. 4 shows a configuration of the image-generating device 3 in which the heat dissipation system 14 is placed upstream of the array of variable transmittance elements. When placed upstream of the array of variable transmittance elements 7, the heat dissipation system 14 absorbs some of the light rays coming from the light sources 6 and dissipates the heat that they generate. These rays therefore do not reach the screen and are advantageously prevented from contributing to its heating up.

In this case, the heat dissipation system 14 is placed between an optical diffuser 21 and the array of variable transmittance elements 7. In this example, the image-generating device 3 comprises an at least partially transparent thermally conductive plate 22, for example in this case a transparent ceramic plate. The downstream face of the plate 22 in this case is in contact with the upstream face of the array of variable transmittance elements 7. The downstream face of the mask 16 in this case is in contact with the upstream face of the plate 22. Thus, the mask 16 is advantageously thermally coupled to the array of variable transmittance elements and makes it possible to limit a rise in temperature of the array 7 owing, for example, to solar rays reaching the downstream face of the array 7.

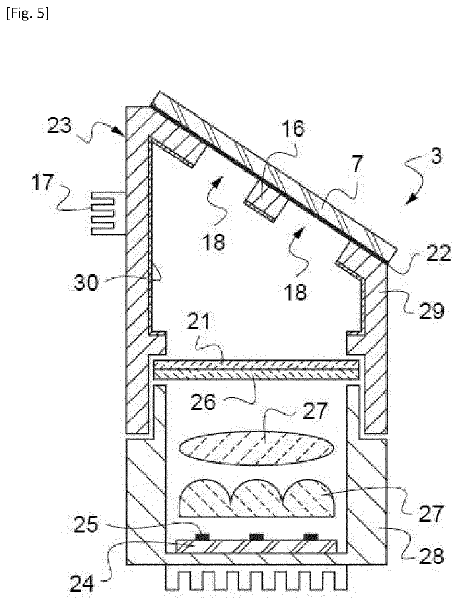

FIG. 5 illustrates an embodiment of this configuration. In this example, the image-generating device 3 comprises a housing 23 at the bottom of which is located the light source 6, in this case a printed circuit board 24 comprising a plurality of light-emitting diodes 26. The light source 6 is located in such a way that it generates a light flux in the direction of openings 18 provided in the wall of the housing 23, opposite the bottom of the housing 23 (which are also the openings in the mask 16, as will be seen below). The transparent ceramic plate 22, on the downstream face of which the array of variable transmittance elements 7 is attached, obstructs these openings.

On the optical path of the rays coming from the light source 6, in other words between the source 6 and the array of variable transmittance elements 7, there are various optical elements, in particular the diffuser 21, a reflective polarizer 26 placed in contact with the upstream face of the diffuser 21, and an optical collimation system 27 placed between the light source 6 and the reflective polarizer 26.

In this example, the housing 23 comprises two independent parts, a first part 28 of which comprises the bottom of the housing 23 and a second part 29 of which comprises the openings 18. The diffuser 21 and the reflective polarizer 26 are held in place by clamping between these two parts 28, 29 of the housing 23.

Advantageously, the second part 29 of the housing 23 forms the mask 16 (or, in other words, the mask 16 is integrated in the second part 29 of the housing 23) and the openings 18 made in the housing form the openings 18 in the mask 16. The heat sink 17 is attached to an outer wall of the second part 29 of the housing 23.

In this example, the inner wall of the second part 28, including the upstream face of the mask 16, is covered with a reflective coating 30. Thus, the second part 29 of the housing 23 forms a reflector and a light ray reflected on the upstream face of the mask 16 could possibly, after several reflections on the inner walls of the housing 23, pass through one of the openings 18. This enhances the brightness of the device 3.

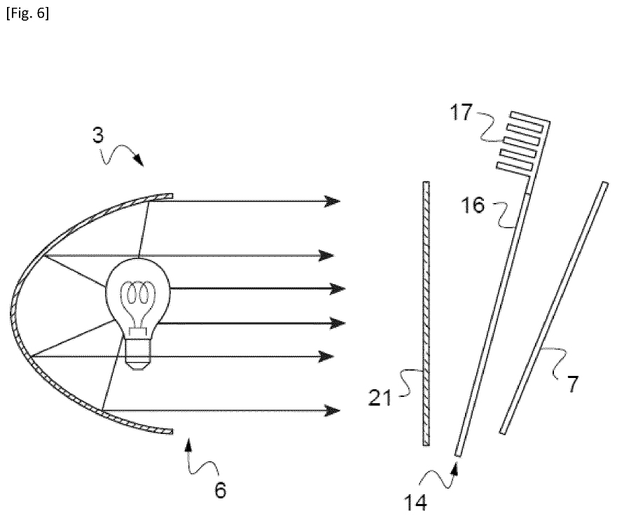

According to another embodiment shown in FIG. 6, the heat dissipation system 14 is located between the optical diffuser 21 and the array of variable transmittance elements 7. The heat dissipation system 14 is in this case at a distance from the array of variable transmittance elements and at a distance from the diffuser 21. No intermediate element is placed between the mask and the array 7 or diffuser 21, at least on the optical route of the light rays the direction of the optical path of which passes through the optically useful zones 15. The distance between the dissipation system 14 and the array of variable transmittance elements 7 advantageously makes it possible to thermally isolate these two elements. Thus, in the case where the rise in temperature owing to the light rays from the light source 6 would be too great for the heat to be dissipated by the system 14, the heat is not directly transmitted to the array of variable transmittance elements 7.

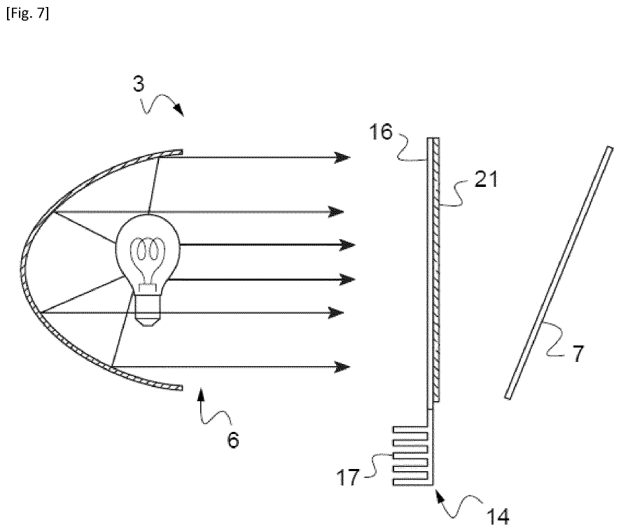

FIG. 7 shows a configuration of the device 3 in which the heat dissipation system 14 is placed upstream of the array of variable transmittance elements 7, in this case between the light source 6 and the diffuser 21. The downstream face of the opaque mask 16 in this case is in contact with the upstream face of the diffuser 21. The dimensions of the mask are in this case substantially the same as those of the diffuser 21, and the heat sink extends beyond the contours of the heat sink 16. This configuration makes it possible to easily attach the heat dissipation system 14 in the image-generating device 3. Furthermore, placing the mask 16 as close as possible to the light source also makes it possible to limit the rise in temperature of the optical elements located further downstream, for example in this case the diffuser 21.

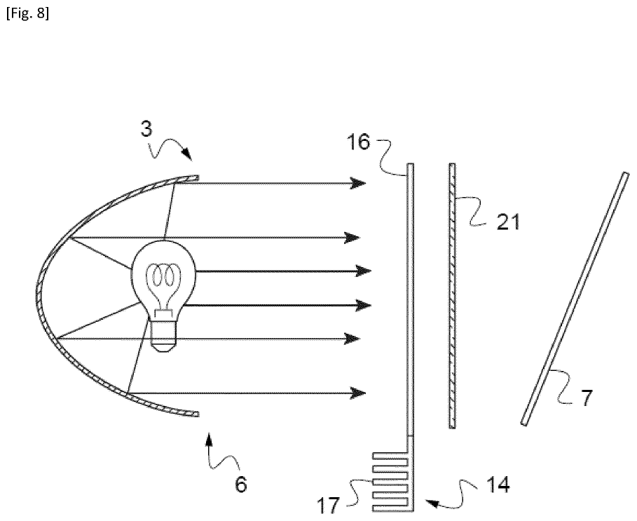

FIG. 8 shows a configuration of the device 3 in which the heat dissipation system 14 is placed upstream of the array of variable transmittance elements 7, in this case between the light source 6 and the diffuser 21. The dimensions of the mask 16 are in this case substantially the same as those of the diffuser 21, and the heat sink 17 extends beyond the contours of the diffuser 21. The heat dissipation system 14 is in this case at a distance from the diffuser 21 and at a distance from the light source 6, and no intermediate element is placed between the mask and the light source 6 or the diffuser 21. At least, no intermediate element is placed on the optical route of the light rays the direction of the optical path of which passes through the optically useful zones 15.

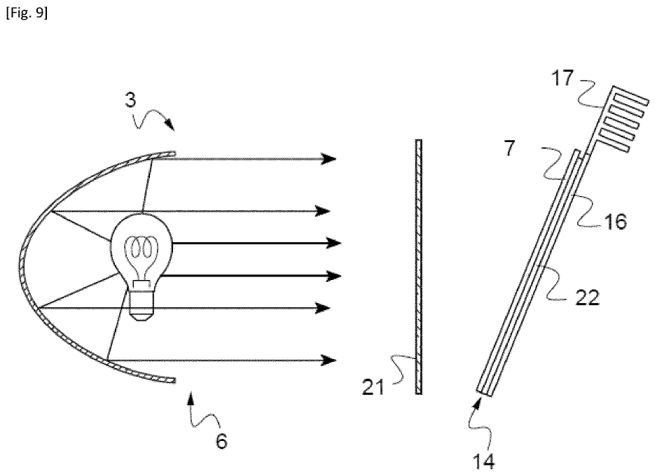

FIG. 9 shows a configuration of the image-generating device 3 in which the heat dissipation system 14 is placed downstream of the array of variable transmittance elements 7. In this configuration, the system 14 advantageously makes it possible to block the solar rays arriving on the downstream face of the array of variable transmittance elements and to dissipate the heat that they generate. In this example, the thermally conductive transparent plate 22 is in contact with the downstream face of the array of variable transmittance elements 7, and the mask 16 is in contact with the downstream face of the transparent ceramic plate 22. Preferably, the mask 16 placed downstream of the array 7 is covered with a black or dark colored coating which makes it possible to absorb solar rays and prevent them from being reflected toward the partially transparent strip.

The invention is not limited to the embodiments described above in connection with FIGS. 1 to 8.

In particular, although an image-generating device comprising a single heat dissipation system 14 has been described, the invention is compatible with devices comprising several heat dissipation systems placed at different locations on the device 3. For example, according to some embodiments, the device comprises a first heat dissipation system placed upstream of the array of variable transmittance elements 7 and a second heat dissipation system placed downstream of the array of variable transmittance elements 7.

Furthermore, the invention is not limited to a heat dissipation system comprising a single mask or a single heat sink. For example, some embodiments of the invention comprise two masks, one placed upstream and the other downstream of the array of variable transmittance elements, and both coupled to the same heat sink. Other embodiments comprise one or more heat dissipation systems each comprising a mask thermally coupled to a plurality of heat sinks.

A mask integrated in a housing the upstream face of which is covered with a reflective coating has been described above, in connection with FIG. 5. The presence of a reflective coating on the upstream face of the mask is not however limited to this embodiment, and may be found in embodiments in which the mask is independent of the housing.

The invention is not limited to a heat sink in contact with the mask. According to some embodiments, the heat sink is not in contact with the mask but is thermally coupled thereto via a thermally conductive material, for example a thermal paste. Alternatively, the mask and the heat sink form a single piece with continuity of material between them.

The mask described above comprises openings obtained from the contours of the active zones, by a homothety with a ratio greater than 1. However, the invention is not limited to such a mask and is compatible with masks having different contours. For example, embodiments include a mask having smaller dimensions than the array of variable transmittance elements and placed facing only a portion of the array of variable transmittance elements.

Lastly, although only one embodiment has been described in which the heat dissipation system 14 is placed downstream of the array, the invention is not limited thereto. Thus, such embodiments may or may not include a thermally conductive transparent plate and the heat dissipation system may be located at any non-zero distance from the array of variable transmittance elements, and be separated therefrom by one or more intermediate elements, provided that the latter do not obstruct the light rays the direction of the optical path of which passes through the optically useful zones.

Various other modifications may be made to the invention within the scope of the appended claims.

1. An image-generating device comprising:
a light source configured to produce a light beam;
an array of variable transmittance elements comprising at least one optically useful zone configured to selectively transmit the light beam; and
a thermally conductive opaque mask located at a distance from the array of variable transmittance elements,
wherein the opaque mask is configured to block light rays in a direction of an optical path which passes through a non-optically useful zone and to allow passage of rays of the light beam in a direction of the optical path which passes through the at least one optically useful zone,
wherein the opaque mask is thermally coupled to a heat sink.

2. The device as claimed in claim 1, wherein contours of the opaque mask are obtained from contours of the at least one optically useful zone by a homothety with a ratio greater than 1.

3. The device as claimed in claim 1, wherein the opaque mask is configured to block all light rays in the direction of the optical path which passes through the non-optically useful zone.

4. The device as claimed in claim 1, wherein the opaque mask is placed upstream of the array of variable transmittance elements relative to a direction of propagation of the light rays.

5. The device as claimed in claim 4, wherein an upstream face of the opaque mask is covered with a reflective coating.

6. The device as claimed in claim 1, further comprising an at least partially transparent and thermally conductive plate in contact with a face of the array of variable transmittance elements, the opaque mask being in contact with the at least partially transparent and thermally conductive plate.

7. The device as claimed in claim 1, further comprising an optical diffuser placed between the light source and the array of variable transmittance elements, the opaque mask being in contact with a face of the optical diffuser.

8. The device as claimed in claim 1, comprising a first opaque mask placed upstream of the array of variable transmittance elements and a second opaque mask placed downstream of the array of variable transmittance elements, relative to a direction of propagation of the light rays.

9. The device as claimed in claim 1, wherein the heat sink is placed on a periphery of the opaque mask.

10. A head-up display comprising an image-generating device as claimed in claim 1 and a control unit configured to control the array of variable transmittance elements such that the variable transmittance elements located outside the at least one optically useful zone permanently have a transmittance of less than 1%.
